(19) United States
(12) Patent Application Publication
(10) Pub. No.: US 2010/0329488 A1
(43) Pub. Date: Dec. 30, 2010

(54) Method and Apparatus for an Active Vehicle Sound Management System

(76) Inventor: Patrick K. Holub, Novi, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/491,269

(22) Filed: Jun. 25, 2009

(51) Int. Cl. H04R 5/02; H04B 1/00

(52) U.S. Cl. 381/301; 381/86

(57) ABSTRACT

An active sound management system for a vehicle includes a plurality of zones defined in the vehicle, each zone including at least one speaker and at least one microphone associated therewith, and a control unit operatively connected to the plurality of zones, the control unit having an input line for receiving an input signal from the at least one microphone of each of the plurality of zones and an output line for sending an output signal to the at least one speaker of each of the plurality of zones. The control unit is capable of selectively communicating with at least one of the plurality of zones defined in the vehicle in a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle in the at least one of the plurality of zones defined in the vehicle when in the at least one of the plurality of selected modes.

### BACKGROUND OF THE INVENTION

This invention relates in general to vehicles and in particular to an improved active sound management system for such a vehicle and method for operation thereof.

The noise or unwanted sound in a vehicle cabin is primarily made up of, or the result of, road, wind and powertrain noise. In current vehicles, sound management systems address these noises actively and/or passively. Typically, the strategies used by these systems to manage vehicle noise attempt to address the concerns of creating acceptable levels of passenger comfort and clear spoken communication between passengers, use of voice recognition command systems and use of vehicle cell phone interfaces. Also, noise concerns in the vehicle cabin space vary in content and intensity depending on driving conditions. At the same time, another concern is that this noise by itself, or together with audio system sound masking, is insufficient to ensure speech privacy between passengers when desired. In view of all of this, addressing some of the above concerns may conflict with other concerns, in that improvements to one or more of the concerns may take away from or degrade performance of one or more of the other concerns.

Thus, it would be desirable to provide an improved active sound management system for a vehicle that is effective to actively manage the sound in the vehicle cabin space and addresses the above concerns with a single set of hardware to reduce or minimize the noise in the vehicle yet is relatively simple and inexpensive.

### SUMMARY OF THE INVENTION

This invention relates to an active sound management system for such a vehicle and method for operation thereof. According to one embodiment, the active sound management system for the vehicle includes a plurality of zones defined in the vehicle, each zone including at least one speaker and at least one microphone associated therewith, and a control unit operatively connected to the plurality of zones, the control unit having an input line for receiving an input signal from the at least one microphone of each of the plurality of zones and an output line for sending an output signal to the at least one speaker of each of the plurality of zones. The control unit is capable of selectively communicating with at least one of the plurality of zones defined in the vehicle in a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle in the at least one of the plurality of zones defined in the vehicle when in the at least one of the plurality of selected modes.

According to another embodiment, the method of operation for the active sound management system for the vehicle comprises the steps of: (a) providing a plurality of zones defined in the vehicle, each zone including at least one speaker and at least one microphone associated therewith; and (b) providing a control unit operatively connected to the plurality of zones, the control unit having an input line for receiving an input signal from the at least one microphone of each of the plurality of zones and an output line for sending an output signal to the at least one speaker of each of the plurality of zones; and (c) operating the control unit whereby the control unit selectively communicates with at least one of the plurality of zones defined in the vehicle in a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle in the at least one of the plurality of zones defined in the vehicle when in the at least one of the plurality of selected modes.

According to yet another embodiment, the method of operation for the active sound management system for the vehicle comprises the steps of: (a) providing a plurality of zones defined in a vehicle, each zone including a speaker and a microphone associated therewith; (b) providing a control unit operatively connected to the plurality of zones, the control unit having an input line for receiving an input signal from the microphone of each of the plurality of zones and an output line for sending an output signal to the speaker of each of the plurality of zones; and (c) operating the control unit whereby the control unit selectively communicates between at least two of the plurality of zones defined in the vehicle in a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle between the at least two of the plurality of zones defined in the vehicle when in the at least one of the plurality of selected modes.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic diagram of an embodiment of an active vehicle sound management system.

FIG. 2 is a schematic diagram showing an embodiment of the operation of the active vehicle sound management system illustrated in FIG. 1.

### DETAILED DESCRIPTION OF THE PREFERRED EMBODIMENTS

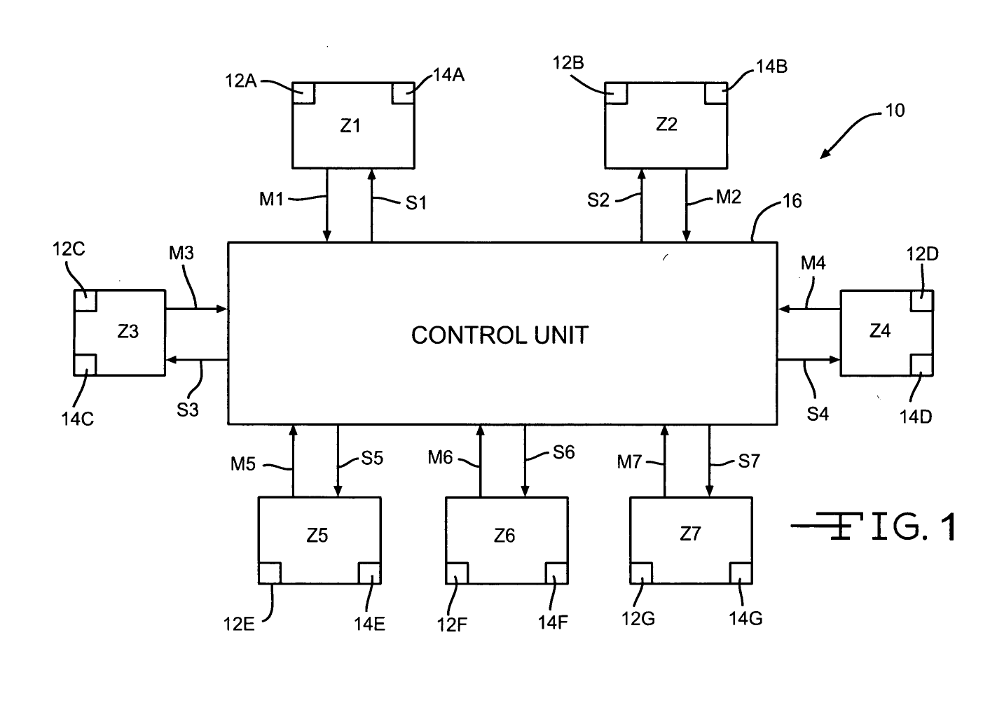

Referring now to FIG. 1, there is illustrated a schematic diagram of a first embodiment of an active vehicle sound management system, indicated generally at 10, constructed in accordance with the present invention. Although this invention will be described and illustrated in connection with the particular type of embodiment of the vehicle disclosed herein, it will be appreciated that this invention may be used in connection with other vehicle types and/or vehicle configurations. Also, as used herein the term “sound” generally refers to both wanted and unwanted sound and the term “noise” generally refers to unwanted sound only.

The illustrated active vehicle sound management system 10 is shown as being adapted for use with a passenger vehicle having a cabin space which is divided into a plurality of seating zones. The term seating zone as used herein can be defined either by one or more individual seats in the vehicle cabin space, by one or more rows of seats in the vehicle cabin space, or by a combination of one or more individual seats with one or more rows of seats in the vehicle cabin space.

In the illustrated embodiment, the vehicle cabin space is divided into seven individual seating zones Z1 to Z7, such as in the case of a minivan or sport utility vehicle. In particular, the seven individual seating zones Z1 to Z7 include three rows in which zones Z1 and Z2 are the first or front row of seats of the vehicle, zones Z3 and Z4 are the second or middle row of seats of the vehicle, and zones Z5-X7 are the third or rear row of seats of the vehicle. Alternatively, the configuration of the zones Z1 to Z7 of the vehicle cabin space for the active vehicle sound management system 10 may be other than illustrated if so desired. For example, the vehicle cabin space of the active vehicle sound management system 10 may include only one zone per row for a total of three, such as in the minivan or sport utility example above, may include only two zones in a single row, such as in the case of a two-seater convertible, may include only two rows with two to six zones, such as in the case of a four door sedan, or may include more than seven zones and/or more than three rows and/or more than three individual seats per row, such as in the case of a bus or other type of commercial vehicle, if so desired. Thus, it can be readily appreciated that the active vehicle sound management system 10 is readily adaptable to accommodate any vehicle cabin space configuration.

As shown in FIG. 1, the zone Z1 includes at least a first “input” member 12A and at least a first “output” member 14A. The first input member 12A may be a microphone 12A and the second output member 14A may be a speaker 14A. Alternatively, the zone Z1 may include more than one microphone 12A and/or more than one speaker 14A if so desired.

The microphone 12A and the speaker 14A are located at predetermined positions within the vehicle cabin space adjacent to the zone Z1. Such predetermined positions can either be fixed positions or can be adjustable positions if so desired. The microphone 12A is operatively connected to a control unit, indicated generally at 16, by a line or circuit M1 and the speaker 14A is operatively connected to the control unit 16 by a line or circuit S1. As will be discussed below in detail, in operation, the microphone 12A provides or generates an input signal from the sound in the zone Z1 to the control unit 16, and the speaker 14A provides or generates sound in the zone Z1 from an output signal from the control unit 16 to the person(s) seated in the zone Z1. As will be discussed below, in the illustrated embodiment, the control unit 16 is preferably an integrated electronic control unit that actively manages or controls the associated sound in the vehicle cabin.

Similarly, in the illustrated embodiment each of the zones Z2 to Z7 includes at least a respective first input member or microphone 12B to 12G, and at least a respective first output member or speaker 14B to 14G. Each of the microphones 12B to 12G is operatively connected to the control unit 16 by a respective line or circuit M2 to M7, and each of the speakers 14B to 14G is operatively connected to the control unit 16 by a respective line or circuit S2 to S7. As will be discussed below in detail, in operation, each of the microphones 12B to 12G provides or generates an input signal from the sound in the zones Z2 to Z7 to the control unit 16, and each of the speakers 14B to 14G provides or generates sound in the zones Z2 to Z7 from an output signal from the control unit 16 to the respective person(s) seated in the zones Z2 to Z7. Alternatively, the construction and/or configuration of one or more of the zones Z1 to Z7 may be other than illustrated if so described.

For example, one or more of the zones Z1 to X7 may include more than one microphone and/or more than one speaker if so desired. In addition, one or more of the zones Z1 to Z7 may be grouped together and include one or more selectively positioned microphones and/or speakers. For example, zones Z1 and Z2 may include a centrally positioned speaker(s) and/or microphone(s); zones Z3 and Z4 may include a centrally positioned speaker(s) and/or microphone(s); and/or zones Z5 to Z7 may include a centrally positioned speaker(s) and/or microphone(s). Also, two or more of the microphones of the zone(s) of the active vehicle sound management system 10 may be configured as an “array microphone” in which tandem signals from two or more omni-directional microphones are sent to, and processed by, the control unit 16. Array microphone algorithms can enhance extraction of vocal sounds from ambient noise and identify acoustic source location (Acoustic Source Localization).

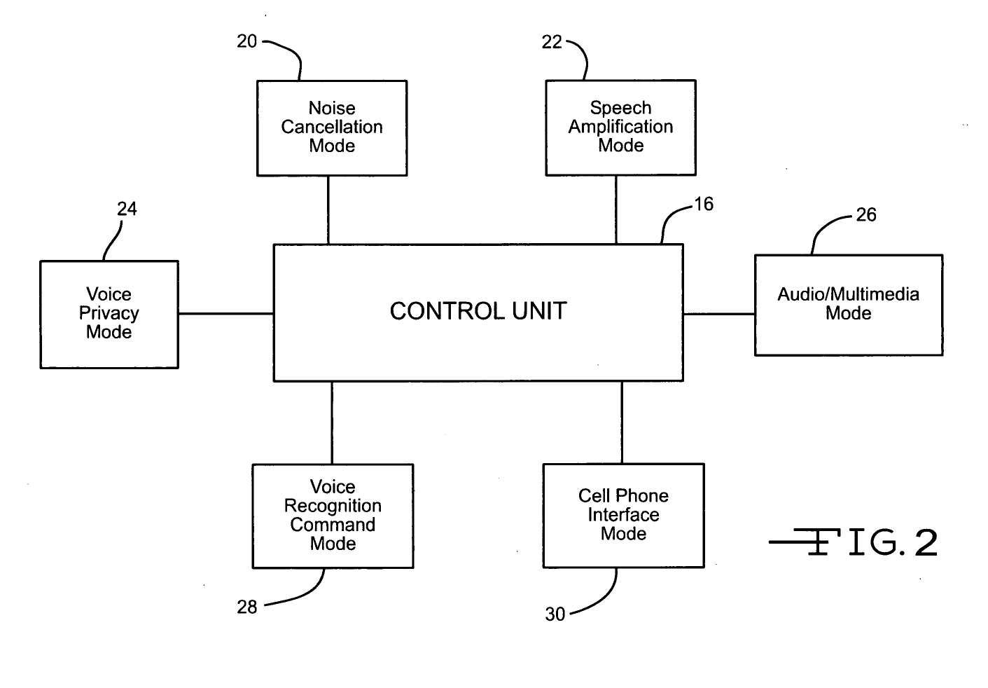

Referring now to FIG. 2, there is illustrated a schematic diagram showing an embodiment of the operation of the control unit 16 of the active vehicle sound management system 10. As will be discussed, the control unit 16 is operative to selectively manage or control the sound in the cabin space of the vehicle in a selected one or more of the plurality of zones or between two or more of the plurality of zones. In the illustrated embodiment, the control unit 16 is capable of managing the sound in six different modes or ways, either by individual modes or in a combination or blending of two or more modes. The six different modes, each of which will be discussed below in detail, include a noise cancellation mode 20, a speech amplification mode 22, a voice privacy mode 24, an audio/multimedia mode 26, a voice recognition mode 28, and a cell phone interface mode 30. As will be discussed below, due to the nature or make up of the particular selected mode(s) 20-30, the control unit 16 is preferably operative to individually manage the sound in a single zone(s) in the voice recognition and cell phone modes; the control unit 16 is preferably operative to manage the sound between two or more of the zones in the speech amplification and voice privacy modes; and the control unit 16 is preferably operative to manage the sound either in a single zone or between two or more of the zones in the noise cancellation and audio/multimedia modes; however, the operation of the control unit 16 can be other than illustrated and described if so desired.

In the illustrated embodiment, the noise cancellation mode 20 is preferably the normal or default mode of the control unit 16 of the active vehicle sound management system 10 and preferably is effective to provide for maximum passenger comfort. In the noise cancellation mode 20 the cabin noise would be reduced or minimized through the filtering of the input from one or more of the microphones 12A to 12G via the lines M1 to M7 to the control unit 16 to maximize the separation of voice and background sounds and the broadcasting through the associated one or more speakers 14A to 14G via the lines S1 to S7 an inverse phased cancelling sound for all controllable background sound frequencies and amplitudes detected at each associated passenger zone Z1 to Z7 to the respective speakers thereof. Noise content identification may be further improved by additional vehicle subsystem input signals being communicated to the control unit 16, such as related transmission or engine speed, gear selection (ratio) or throttle position. The resulting filtered speech signal from the control unit 16 could then be used for an input to the systems voice recognition command mode 28 and/or cell phone interface mode 30 described below. Alternatively, the configuration and/or the operation of the noise cancellation mode 20 may be other than illustrated and described if so desired.

In the illustrated speech amplification or intercom mode 22, spoken communication from one or more microphones 12A to 12G from respective zones Z1 to Z7 transmitted by lines M1 to M7 to the control unit 16 would be enhanced by amplification and transmission of the separated voice signals by the control unit 16 to one or more of the associated speakers 14A to 14G of the other selected zones Z1 to Z7 via the lines S1 to S7. The speech amplification mode 22 would preferably remain separate from the noise cancellation mode 20 to prevent voice amplification between zones when it is not needed or desired. The speech amplification mode 22 would preferably provide for auto-adjustment of the voice signal amplification to maintain a constant signal to noise ratio for each cabin zone regardless of driving conditions. By analyzing the voice signal to noise ratio at each zone microphone 12A to 12G, the control unit 16 of the active vehicle sound management system 10 would preferably automatically determine which zone speakers 14A to 14G should not be sent the amplified output signal via the lines S1 to S7 (i.e., no need to broadcast the amplified speech into the zone of the person speaking). Alternatively, the configuration and/or the operation of the speech amplification or intercom mode 22 may be other than illustrated and described if so desired.

In the illustrated voice privacy mode 24, the control unit 16 would use the inputs via the lines M1 to M7 from one or more zone microphones 12A to 12G to adjust the volume and/or content of voice masking sound delivered via the lines S1 to S7 to one or more of the speakers 14A to 14G of the other zones. The masking sound may be of any suitable type, such as for example, white noise, pink noise, vehicle adaptation of random segments and overlays of prerecorded speech, and sound cancellation of the vocal frequencies. Alternatively, the configuration and/or the operation of the voice privacy mode 24 may be other than illustrated and described if so desired.

In the illustrated audio/multimedia mode 26, one or more zones Z1 to Z7 of audio content could be simultaneously output by the control unit 16 to the speakers 14A to 14G via the lines S1 to S7. During this mode, sound cancellation algorithms could be used to minimize background vehicle/road noise and also to create cancelling signals of the audio content of other active zones. Other features or enhancements of this mode may include: a) auto-adjustment of the volume balance between two or more of the speakers 14A to 14G of one or more zones Z1 to Z7 from the vehicle's audio/multimedia system based on listener location(s) in the vehicle cabin space; and b) auto-adjustment of speaker volume to maintain a constant signal to noise ratio for each associated listener cabin zone Z1 to Z7 regardless of driving conditions. Alternatively, the configuration and/or the operation of the audio/multimedia mode 26 may be other than illustrated and described if so desired.

In the illustrated voice recognition command mode 28, the control unit 16 would house and utilize voice recognition software to facilitate communication between at least one zone and at least one other vehicle subsystem, including the active vehicle sound management system 10 itself. During the voice recognition command mode 28, spoken verbal commands to one or more zone microphones 12A to 12G would facilitate the use of all the vehicle's equipped voice commanded systems by preferably any vehicle passenger (preferably in zones Z3 to Z7), rather than just those passenger(s) in the zones Z1 and Z2 (i.e., the front row seats). Alternatively, the configuration and/or the operation of the voice recognition command mode 28 may be other than illustrated and described if so desired.

In the illustrated cell phone interface mode 30, the control unit 16 would use the inputs via the lines M1 to M7 from the zone microphones 12A to 12G to facilitate cell phone conversation participation by any vehicle passenger (preferably in zones Z3 to Z7), rather than just those passenger(s) in the zones Z1 and Z2 (i.e., the front row seats). Alternatively, the configuration and/or the operation of the cell phone interface mode 30 may be other than illustrated and described if so desired.

Thus, it can be seen that depending on the above described mode 20 to 30 which is selected, the control unit 16 of the active vehicle sound management system 10 is capable of processing the inputs via the lines M1 to M7 from the zone microphones 12A to 12G to generate signals to the speakers 14A to 14G via the lines S1 to S7 to execute the functions outlined above for the selected mode(s).

One advantage of the embodiments of the present invention is that the active vehicle sound management system 10 integrates and actively performs all of the above described modes 20 to 30 into a single system. Additionally, the active vehicle sound management system 10 should be able to be accomplished with little additional electronic hardware, i.e., more controller software/memory and microphones for each passenger zone (each zone is normally equipped with a speaker and the driver zone is normally equipped with a microphone). However, the benefits provided by the active vehicle sound management system 10 may offset any such added costs, and reduce weight, by reducing the need for passive sound insulation, by sharing control system components normally duplicated in independent subsystems and/or by simplifying or eliminating some traditional subsystem control interfaces (i.e., multimedia and/or climate control switches and knobs).

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. An active sound management system for a vehicle comprising:
a plurality of zones defined in the vehicle, each zone including at least one speaker and at least one microphone associated therewith; and
a control unit operatively connected to the plurality of zones, the control unit having an input line for receiving an input signal from the at least one microphone of each of the plurality of zones and an output line for sending an output signal to the at least one speaker of each of the plurality of zones;
wherein the control unit is capable of selectively communicating with at least one of the plurality of zones defined in the vehicle in at least one of a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle in the at least one of the plurality of zones defined in the vehicle when in the at least one of the plurality of selected modes.

2. The active sound management system for a vehicle of claim 1 wherein the control unit is capable of selectively communicating between at least two of the plurality of zones defined in the vehicle in at least one of the plurality of selected modes.

3. The active sound management system for a vehicle of claim 2, wherein the at least two of the plurality of zones is selected from the group consisting of at least two individual seats in the vehicle, at least two rows of seats in the vehicle, and at least one individual seat in the vehicle and at least one row of seats in the vehicle.

4. The active sound management system for a vehicle of claim 1 wherein in the noise cancellation mode, noise within the vehicle would be reduced or minimized through filtering of the input signal from at least one microphone from at least one zone to the control unit to maximize the separation of voice and background sounds and broadcast through at least one speaker of the at least one zone an inverse phased cancelling sound for all controllable background sound frequencies and amplitudes detected at the at least one zone to the at least one speaker thereof.

5. The active sound management system for a vehicle of claim 2 wherein in the speech amplification mode, spoken communication from at least one microphone from one of the at least two plurality of zones is transmitted to the control unit and separated voice signals are enhanced by amplification and are transmitted by the control unit to the at least one speaker of the other one of the at least two plurality of zones.

6. The active sound management system for a vehicle of claim 2 wherein in the illustrated voice privacy mode, the control unit uses the input from at least one microphone from one of the at least two plurality of zones to adjust the volume and/or content of voice masking sound delivered to the at least one speaker of the other one of the at least two plurality of zones.

7. The active sound management system for a vehicle of claim 1 wherein in the audio/multimedia mode, audio content of at least one zone is output by the control unit to the at least one speaker of the at least one zone and wherein noise cancellation algorithms are used to minimize background vehicle/road noise in the at least one zone and to create cancelling signals of the audio content to the at least one speaker of any other active zone and of any desired inactive zone.

8. The active sound management system for a vehicle of claim 1 wherein in the voice recognition command mode, the control unit uses the input signals from at least one microphone at the at least one zone to facilitate voice recognition of a vehicle passenger in the at least one zone.

9. The active sound management system for a vehicle of claim 1 wherein in the cell phone interface mode, the control unit uses the input signal from at least one microphone at the at least one zone to facilitate cell phone conversation participation by a vehicle passenger in the at least one zone.

10. A method of operation for an active sound management system for a vehicle comprising the steps of:
(a) providing a plurality of zones defined in the vehicle, each zone including at least one speaker and at least one microphone associated therewith;
(b) providing a control unit operatively connected to the plurality of zones, the control unit having an input line for receiving an input signal from the at least one microphone of each of the plurality of zones and an output line for sending an output signal to the at least one speaker of each of the plurality of zones; and
(c) operating the control unit whereby the control unit selectively communicates with at least one of the plurality of zones defined in the vehicle in a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle in the at least one of the plurality of zones defined in the vehicle when in the at least one of the plurality of selected modes.

11. The method of operation for an active sound management system for a vehicle of claim 10 wherein in step (c) the control unit is capable of selectively communicating between at least two of the plurality of zones defined in the vehicle in at least one of the plurality of selected modes.

12. The method of operation for an active sound management system for a vehicle of claim 11 wherein the at least two of the plurality of zones in step (c) is selected from the group consisting of at least two individual seats in the vehicle, at least two rows of seats in the vehicle, and at least one individual seat in the vehicle and at least one row of seats in the vehicle.

13. The method of operation for an active sound management system for a vehicle of claim 10 wherein in step (c) the noise cancellation mode, noise within the vehicle would be reduced or minimized through filtering of the input signal from at least one microphone from at least one zone to the control unit to maximize the separation of voice and background sounds and broadcast through at least one speaker of the at least one zone an inverse phased cancelling sound for all controllable background sound frequencies and amplitudes detected at the at least one zone to the at least one speaker thereof.

14. The method of operation for an active sound management system for a vehicle of claim 11 wherein in step (c) the speech amplification mode, spoken communication from at least one microphone from one of the at least two plurality of zones is transmitted to the control unit and separated voice signals are enhanced by amplification and are transmitted by the control unit to the at least one speaker of the other one of the at least two plurality of zones.

15. The method of operation for an active sound management system for a vehicle of claim 11 wherein in step (c) the illustrated voice privacy mode, the control unit uses the input from at least one microphone from one of the at least two plurality of zones to adjust the volume and/or content of voice masking sound delivered to the at least one speaker of the other one of the at least two plurality of zones.

16. The method of operation for an active sound management system for a vehicle of claim 10 wherein in step (c) the audio/multimedia mode, audio content of at least one zone is output by the control unit to the at least one speaker of the at least one zone and wherein noise cancellation algorithms are used to minimize background vehicle/road noise in the at least one zone and to create cancelling signals of the audio content to the at least one speaker of any other active zone and of any desired inactive zone.

17. The method of operation for an active sound management system for a vehicle of claim 10 wherein in step (c) the voice recognition command mode, the control unit uses the input signals from at least one microphone at the at least one zone to facilitate voice recognition of a vehicle passenger in the at least one zone.

18. The method of operation for an active sound management system for a vehicle of claim 10 wherein in step (c) the cell phone interface mode, the control unit uses the input signal from at least one microphone at the at least one zone to facilitate cell phone conversation participation by a vehicle passenger in the at least one zone.

19. A method of operation for an active sound management system for a vehicle comprising the steps of:
(a) providing a plurality of zones defined in a vehicle, each zone including a speaker and a microphone associated therewith;
(b) providing a control unit operatively connected to the plurality of zones, the control unit having an input line for receiving an input signal from the microphone of each of the plurality of zones and an output line for sending an output signal to the speaker of each of the plurality of zones; and
(c) operating the control unit whereby the control unit selectively communicates between at least two of the plurality of zones defined in the vehicle in a plurality of selected modes, the plurality of selected modes being selected from a group consisting of a noise cancellation mode, a speech amplification mode, a voice privacy mode, an audio/multimedia mode, a voice recognition mode, and a cell phone interface mode, whereby the control unit is operative to manage the sound in the vehicle between the at least two of the plurality of zones defined in the vehicle when in the at least one of the plurality of selected modes.

20. The method of operation for an active sound management system for a vehicle of claim 19 wherein the at least two of the plurality of zones in step (c) is selected from the group consisting of at least two individual seats in the vehicle, at least two rows of seats in the vehicle, and at least one individual seat in the vehicle and at least one row of seats in the vehicle.
